(19) United States
(12) Patent Application Publication
(10) Pub. No.: US 2025/0259271 A1
(43) Pub. Date: Aug. 14, 2025

(54) IMAGE PROCESSING APPARATUS, RADIATION IMAGING SYSTEM, IMAGE PROCESSING METHOD, AND STORAGE MEDIUM

(71) Applicant: CANON KABUSHIKI KAISHA, Tokyo (JP)

(72) Inventor: Misaki KOSUGI, Saitama (JP)

(21) Appl. No.: 19/037,392

(22) Filed: Jan. 27, 2025

(30) Foreign Application Priority Data
Feb. 8, 2024 (JP) 2024-018021

(51) Int. Cl. G06T 5/50

(52) U.S. Cl. CPC G06T 5/50; G06T 2207/10116

(57) ABSTRACT

An image processing method includes: obtaining a radiological image that includes a plurality of pixel values obtained from a plurality of imaging pixels through radiation imaging, wherein the plurality of imaging pixels are arranged; determining, from among the plurality of pixel values, a pixel value obtained from a first type of imaging pixel of the plurality of imaging pixels and a pixel value obtained from a second type of imaging pixel having a different configuration from the first type of imaging pixel; and performing a first correction process in which the pixel value obtained from the first type of imaging pixel is set as a correction target, and performing a second correction process that differs from the first correction process, and in which the pixel value obtained from the second type of imaging pixel is set as a correction target.

### BACKGROUND OF THE INVENTION

### Field of the Invention

The present disclosure relates to an image processing apparatus, a radiation imaging system, an image processing method, and a storage medium.

### Description of the Related Art

Radiation imaging apparatuses (flat panel detectors, also referred to as “FPDs”) that include: conversion elements that convert radiation into electric charges, pixel arrays on which switch elements such as thin-film transistors are provided, drive circuits, and readout circuits have been widely used. In recent years, the multifunctionality of this type of radiation imaging apparatus has been examined, and, as an example thereof, adding a function of grasping irradiation information of radiation while the radiation is emitted from a radiation source has been examined. The irradiation information is used for detection of a timing of start of incidence of radiation emitted from the radiation source, and detection of an accumulated irradiation amount, for example. The accumulated irradiation amount can be used for an AEC (automatic exposure control) function that is performed by a radiation imaging apparatus, for example. In the AEC function, the radiation imaging apparatus monitors the accumulated irradiation amount, and controls the radiation source to automatically end irradiation from the radiation source at a timepoint when the accumulated irradiation amount reaches an appropriate amount.

Japanese Patent Laid-Open No. 2013-135389 describes an FPD that includes compound pixels each composed of a main pixel and a sub pixel from which electric charges can be read out to separate signal lines. With the FPD in Japanese Patent Laid-Open No. 2013-135389, image signals for forming a radiological image are obtained from the main pixels, and signals of irradiation information are obtained from the sub pixels. The FPD has the AEC function for controlling the radiation source and ending irradiation in accordance with a result of comparing the accumulated irradiation amount obtained based on the irradiation information with a threshold set in advance.

With the FPD in Japanese Patent Laid-Open No. 2013-135389, the compound pixels each composed of a main pixel and a sub pixel have a different output property from that of normal pixels that are not compound pixels, and thus there are cases where a degradation in the image quality of a radiological image occurs. In Japanese Patent Laid-Open No. 2013-135389, an attempt is made to correct image signals obtained from the compound pixels (main pixels) in order to reduce or prevent such a degradation in the image quality. Specifically, correction is performed by multiplying the ratio of the total aperture area of a single pixel to the aperture area of the main pixel thereof (hereinafter, an “aperture rate”), or the ratio of total output of a compound pixel in response to radiation emitted under a certain condition to output of the main pixel thereof, by an image signal of the main pixel. Note that the total output of the compound pixel is the sum of output of the main pixel and output of the sub pixel.

In Japanese Patent Laid-Open No. 2013-135389, a coefficient for correction is determined based on an aperture rate that is determined based on the structure of the elements of the compound pixel or the ratio of output that is obtained from the compound pixel under a specific irradiation condition. However, according to examination performed by the present inventor, the difference between output from a normal imaging pixel and output from a compound pixel (main pixel) that has a different property from the normal imaging pixel due to the influence from the sub pixel of the compound pixel or the like also changes in accordance with an imaging environment and an irradiation condition. Moreover, it was found that this change in the output difference significantly affects the image quality of a radiological image that is obtained. For this reason, Japanese Patent Laid-Open No. 2013-135389 in which an imaging environment and an irradiation condition are not taken into consideration, it is impossible to sufficiently prevent degradation in the image quality of a radiological image.

The present disclosure provides a technique for improving the image quality of a radiological image that is obtained from a radiation imaging apparatus that includes imaging pixels having different properties due to structural differences.

### SUMMARY OF THE INVENTION

According to one aspect of the present invention, there is provided an image processing apparatus comprising: one or more controllers configured to: obtain a radiological image that includes a plurality of pixel values obtained from a plurality of imaging pixels through radiation imaging, wherein the plurality of imaging pixels are two-dimensionally arranged; determine, from among the plurality of pixel values, a pixel value obtained from a first type of imaging pixel of the plurality of imaging pixels and a pixel value obtained from a second type of imaging pixel having a different configuration from the first type of imaging pixel; and perform a first correction process in which the pixel value obtained from the first type of imaging pixel is set as a correction target, and perform a second correction process that is different from the first correction process, and in which the pixel value obtained from the second type of imaging pixel is set as a correction target, wherein, in the second correction process, a correction process to be applied to the correction-target pixel value is determined based on pixel value information obtained from a pixel value of a portion of the radiological image.

According to another aspect of the present invention, there is provided a radiation imaging system that includes a radiation imaging apparatus and an image processing apparatus, wherein, in the radiation imaging apparatus, a plurality of imaging pixels are two-dimensionally arranged, the plurality of imaging pixels including a first type of imaging pixel that has a configuration in which a single conversion element is disposed in a region of one pixel, and a second type of imaging pixel having a configuration in which two conversion elements each capable of reading out an electric charge independently are disposed in a region of one pixel, and a pixel value is provided from one of the two conversion elements, the image processing apparatus that processes a radiological image that includes a plurality of pixel values obtained from the plurality of imaging pixels through radiation imaging that is performed using the radiation imaging apparatus, the image processing apparatus including: one or more controllers configured to: determine, among the plurality of pixel values, a pixel value obtained from the first type of imaging pixel and a pixel value obtained from the second type of imaging pixel, and perform a first correction process in which the pixel value obtained from the first type of imaging pixel is set as a correction target, and perform a second correction process that is different from the first correction process, and in which the pixel value obtained from the second type of imaging pixel is set as a correction target, wherein, in the second correction process, a correction process to be applied to the correction-target pixel value is determined based on pixel value information obtained from a pixel value of a portion of the radiological image.

According to still another aspect of the present invention, there is

provided an image processing method comprising: obtaining a radiological image that includes a plurality of pixel values obtained from a plurality of imaging pixels through radiation imaging, wherein the plurality of imaging pixels are two-dimensionally arranged; determining, from among the plurality of pixel values, a pixel value obtained from a first type of imaging pixel of the plurality of imaging pixels and a pixel value obtained from a second type of imaging pixel having a different configuration from the first type of imaging pixel; and performing a first correction process in which the pixel value obtained from the first type of imaging pixel is set as a correction target, and performing a second correction process that is different from the first correction process, and in which the pixel value obtained from the second type of imaging pixel is set as a correction target, wherein, in the second correction process, a correction process to be applied to the correction-target pixel value is determined based on pixel value information obtained from a pixel value of a portion of the radiological image.

Further features of the present invention will become apparent from the following description of exemplary embodiments (with reference to the attached drawings).

### BRIEF DESCRIPTION OF THE DRAWINGS

FIG. 1 is a block diagram showing a configuration example of a radiation imaging system according to a first embodiment.

FIG. 2 is a block diagram showing a configuration example of a radiation imaging apparatus according to the first embodiment.

FIG. 3 is a diagram showing a detailed configuration of an amplifier in the radiation imaging apparatus.

FIG. 4 is a flowchart showing radiation imaging processing according to the first embodiment.

FIG. 5 is a flowchart showing a pixel correction process according to the first embodiment.

FIGS. 6A and 6B are flowcharts showing a pixel correction process that is based on a radiation dose/a pixel value.

FIG. 7 is a flowchart showing radiation imaging processing according to a second embodiment.

FIGS. 8A and 8B are flowcharts showing a pixel correction process according to the second embodiment.

FIGS. 9A and 9B are flowcharts illustrating a correction process according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In addition, a term “radiation” can typically refer to X-rays, but there is no limitation to X-rays, and other radiation (for example, α-rays, β-rays, and γ-rays) is also applicable.

### First Embodiment

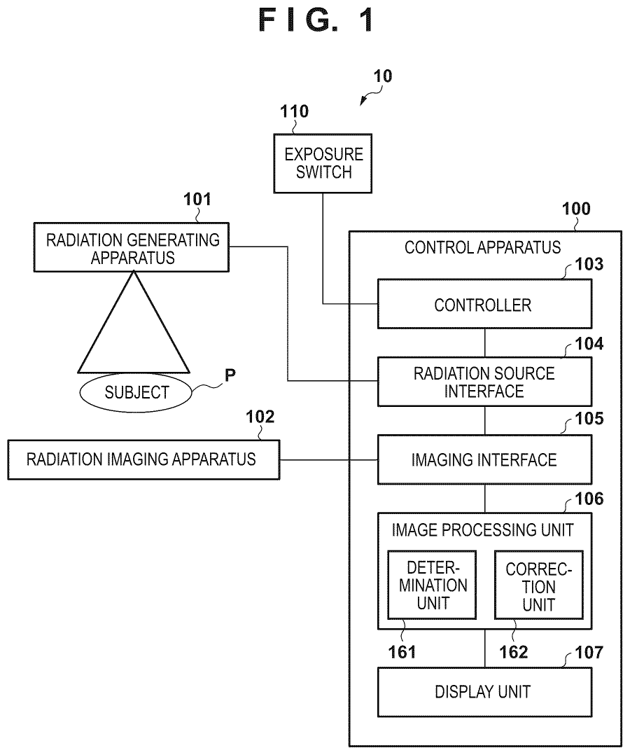

FIG. 1 is a block diagram showing an exemplary overall configuration of a radiation imaging system 10 according to a first embodiment. The radiation imaging system 10 includes a control apparatus 100, a radiation generating apparatus 101, and a radiation imaging apparatus 102. Note that FIG. 1 shows an example in which the control apparatus 100 performs communication with the radiation imaging apparatus 102 and the radiation generating apparatus 101 by wire, but a configuration can also be adopted in which wireless communication is performed. In addition, a configuration of a portion or the entirety of the control apparatus 100 may be provided in the radiation imaging apparatus 102.

The control apparatus 100 controls a dose (irradiation dose) of radiation emitted from the radiation generating apparatus 101, by providing radiation generation conditions such as a tube current, a tube voltage, and the like to the radiation generating apparatus 101. In addition, the control apparatus 100 performs image processing on a radiological image received from the radiation imaging apparatus 102, thereby generating a radiological image in which an artifact or the like has been reduced or prevented. The control apparatus 100 according to the present embodiment includes a controller 103, a radiation source interface 104, an imaging interface 105, an image processing unit 106, and a display unit 107 as functional units. A general-purpose computer equipped with a processor (CPU), a main storage device, a secondary storage device, and a display can be used as the control apparatus 100, and, in this case, the aforementioned functional units are realized by the processor executing a predetermined program.

The controller 103 includes a user interface, and accepts user input for setting a radiation dose target value, irradiation intensity (including an irradiation time (ms), a tube current (mA), and a tube voltage (kV), for example), a light-receiving field that is a region where radiation is detected, and the like. The radiation dose target value is used to determine whether or not to end irradiation in AEC (automatic exposure control), and, for example, an EI (exposure index) value that is a radiation dose index value can be used as the radiation dose target value. The controller 103 sets input irradiation intensity in the radiation generating apparatus 101 via the radiation source interface 104. In addition, the controller 103 determines a radiation dose target value, irradiation intensity, communication delay between units, and a radiation dose target threshold that is used for AEC (automatic exposure control) based processing delay on the like. The radiation dose target threshold is set in the radiation imaging apparatus 102 via the imaging interface 105.

An exposure switch 110 for instructing the radiation generating apparatus 101 to start irradiation is connected to the controller 103. Immediately after the radiation imaging apparatus 102 is turned on, or each time one instance of radiation imaging ends, the radiation imaging apparatus 102 performs an operation of resetting an electric circuit, such as an operation of reading the circuit with no load at least once, and outputs a preparation complete signal when a predetermined condition is met. Reading a circuit with no load refers to a readout operation for resetting an electric charge caused by charge accumulation of a dark current in a conversion element or the like of the radiation imaging apparatus 102, and, in a case where this operation is executed a plurality of times, the operation is repeated in a predetermined cycle. In addition, it is possible to use, as the predetermined condition, at least one of a predetermined time having elapsed from when a reset operation was started, a signal value obtained by reading a circuit with no load being smaller than a threshold, and the like. Here, a configuration may be adopted in which a predetermined time can be set by the user. If the exposure switch 110 is operated by the user after a preparation complete signal is received from the radiation imaging apparatus 102 via the imaging interface 105, the controller 103 transmits an instruction to start irradiation to the radiation generating apparatus 101 via the radiation source interface 104. The radiation generating apparatus 101 that has received a signal for instructing that irradiation is started starts irradiation with the set irradiation intensity. The radiation imaging apparatus 102 detects irradiation, starts accumulation of electric charges, and radiation imaging is thereby started.

The radiation imaging apparatus 102 has an AEC function for determining whether or not to end imaging, based on a signal (radiation dose information) read out from the detection element 2052 to be described later. The radiation imaging apparatus 102 obtains an accumulated value of irradiation dose based on a signal of the detection element 2052, and transmits a stop notice to the control apparatus 100 when the accumulated value reaches a target threshold. The stop notice is a signal requesting that irradiation ¥be ended. In accordance with the imaging interface 105 receiving the stop notice from the radiation imaging apparatus 102, the radiation source interface 104 transmits an instruction to end irradiation, to the radiation generating apparatus 101. Upon receiving the signal instructing the irradiation be ended, the radiation generating apparatus 101 ends irradiation.

When radiation imaging ends, the imaging interface 105 receives radiological image data from the radiation imaging apparatus 102, and outputs the radiological image data to the image processing unit 106. The image processing unit 106 performs image processing such as an offset correction process, a gain correction process, and noise reducing processing on a radiological image. A determination unit 161 classifies pixel values according to a type of configuration of imaging pixel, and a correction unit 162 applies different correction processes in accordance with the classification result, to the pixel values. Processing that is performed by the determination unit 161 and the correction unit 162 will be described in detail later. The image processing unit 106 transmits radiological image data subjected to image processing, to the display unit 107. The display unit 107 converts the radiological image data obtained from the image processing unit 106 into a two-dimensional image (radiological image), and displays the two-dimensional image (radiological image) after conversion, on a general-purpose display or the like. An operator can thereby observe a radiological image of a subject P. The control apparatus 100 that includes the image processing unit 106 is an example of an image processing apparatus according to the present disclosure.

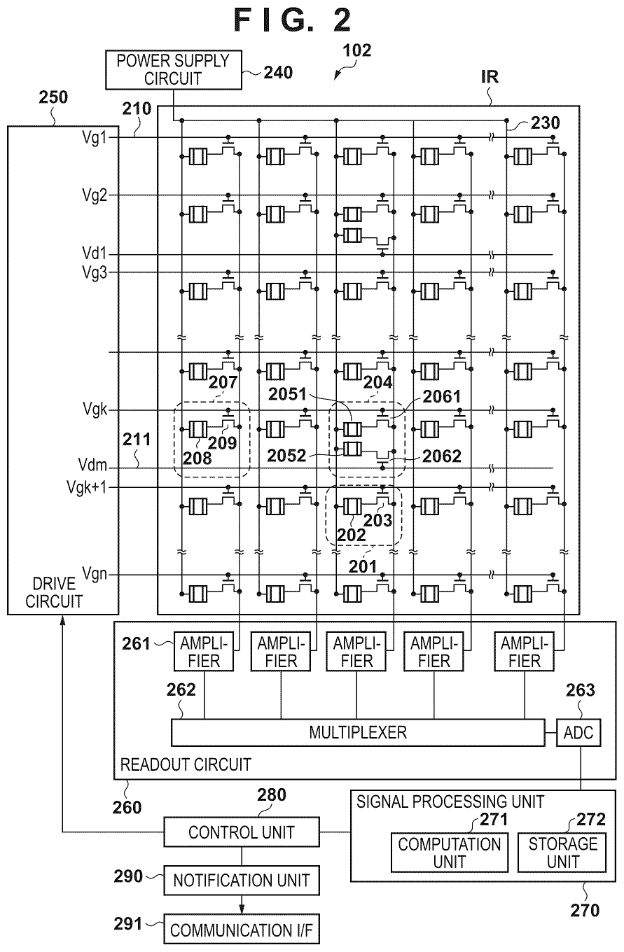

FIG. 2 is a block diagram showing a configuration example of the radiation imaging apparatus 102 according to the first embodiment. The radiation imaging apparatus 102 includes a plurality of imaging pixels that include a plurality of types of imaging pixels 201, 204, and 207, a plurality of drive lines 210 for driving the plurality of imaging pixels, and a plurality of signal lines 220 for obtaining signals from the plurality of imaging pixels. The plurality of imaging pixels are two-dimensionally arranged in an imaging region IR and form a plurality of rows and a plurality of columns. The plurality of drive lines 210 are arranged in correspondence with the plurality of pixel rows, and each of the drive lines 210 corresponds to one pixel row. The plurality of signal lines 220 are arranged in correspondence with the plurality of pixel columns, and each of the signal lines 220 corresponds to one pixel column.

The plurality of imaging pixels include a plurality of imaging pixels 201, at least one imaging-and-detection pixel 204, and a plurality of imaging pixels 207 that are on the same row as the imaging-and-detection pixel 204. In the present embodiment, the imaging pixels 201, the imaging-and-detection pixel 204, and the imaging pixels 207 are respectively handled as a first type of imaging pixels, a second type of imaging pixel, and a third type of imaging pixels having different configurations. Although the configurations of these types of imaging pixels will be described below, at least one of sensitivity to an irradiation dose, noise, an aperture rate, parasitic capacitance, linearity, a saturation property, an offset property, and the like is different among imaging pixels having different configurations. Such differences in property can affect a radiological image, and cause a degradation in the image quality.

The imaging pixels 201 of the first type have a configuration in which a single photoelectric conversion element (imaging element 202) is disposed in the region of one pixel. The imaging-and-detection pixel 204 of the second type has a configuration in which two photoelectric conversion elements that independently read out electric charges are disposed in the region of one pixel. One of the two photoelectric conversion elements is an imaging element 2051 for obtaining a pixel value that makes up a radiological image, and the other is a detection element 2052 for monitoring an irradiation amount at the time of AEC control. The imaging pixels 207 of the third type has a configuration in which a single photoelectric conversion element (imaging element 208) for obtaining a radiological image is present in the region of one pixel. Note that the imaging pixels 207 are imaging pixels aligned in the same row as the imaging-and-detection pixel 204, and an interconnect (a detection drive line 211) for controlling the detection element 2052 of the imaging-and-detection pixel 204 passes through the region of the pixel. An area allocated to the imaging-and-detection pixel 204 is divided by the imaging element 2051 and the detection element 2052. For this reason, the area (aperture rate) of the imaging element 2051 is smaller than the area of each imaging pixel 201. In addition, the imaging element 208 of each imaging pixel 207 is affected by the detection drive line 211, and the aperture rate thereof becomes smaller than the imaging element 202 of the imaging pixel 201, for example. Due to the above configurations, the imaging pixel 201, the imaging-and-detection pixel 204, and the imaging pixel 207 are imaging pixels having different properties. In the present embodiment, the property of the imaging pixel 201 is used as a criterion. Note that, hereinafter, the imaging pixel 201 is also referred to as a “normal imaging pixel”, and the imaging pixel 207 is also referred to as an “imaging pixels in an AEC row”.

The imaging pixel 201 includes the imaging element 202 that is a conversion element that converts radiation into an electrical signal, and a switch element 203 that connects the corresponding signal line 220 and the imaging element 202 to each other. Similarly, the imaging pixel 207 includes the imaging element 208 that is a conversion element that converts radiation into an electrical signal, and a switch element 209 that connects the corresponding signal line 220 and the imaging element 208 to each other. The imaging-and-detection pixel 204 includes the imaging element 2051 that is a conversion element that converts radiation into an electrical signal and the detection element 2052. An imaging switch element 2061 that connects the corresponding signal line 220 and the imaging element 2051 to each other is connected to the imaging element 2051. In addition, a detection switch element 2062 that connects the corresponding signal line 220 and the detection element 2052 to each other is connected to the detection element 2052. It is possible to perform radiation dose detection during irradiation using the detection element 2052 while holding radiation information for a radiological image in the imaging element 2051, by dividing one imaging-and-detection pixel 204 into the imaging element 2051 and the detection element 2052. Radiation dose detection that is performed by the detection element 2052 can be used for the AEC function. The imaging-and-detection pixel 204 is included in a row and a column formed by imaging pixels 201 and imaging pixels 207.

The imaging elements 202, 208, and 2051 and the detection element 2052 may include a scintillator that converts radiation into light and photoelectric conversion elements that convert light into electrical signals. In general, the scintillator is formed as a sheet that covers the imaging region IR, and is shared by a plurality of pixels. Note that the imaging elements 202, 208, and 2051, and the detection element 2052 may each be composed of a conversion element that directly converts radiation into an electrical signal.

The switch elements 203, 209, 2053, and 2054 may include a thin-film transistor (TFT) in which an active region is made of a semiconductor such as amorphous silicon or polycrystalline silicon. In the imaging pixel 201, a first electrode of the imaging element 202 is connected to a first main electrode of the switch element 203. A second electrode of the imaging element 202 is connected to a bias line 230. The bias line 230 includes a plurality of column-direction bias lines extending in the column direction, and the second electrodes of a plurality of imaging elements 202 arranged in the same row are connected to the respective column-direction bias lines. A bias voltage Vs that is supplied from a power supply circuit 240 is applied to the second electrode of the imaging element 202 via the bias line 230. A second main electrode of the switch element 203 of at least one imaging pixel 201 included in one column is connected to one signal line 220. A control electrode of the switch element 203 of the imaging pixel 201 is connected to the drive line 210. The same applies to the imaging pixels 207. That is to say, a first electrode of the imaging element 208 is connected to a first main electrode of the switch element 209, and a second electrode of the imaging element 208 is connected to the bias line 230. In addition, a second main electrode of the switch element 209 is connected to the signal line 220.

In the imaging-and-detection pixel 204, a first electrode of the imaging element 2051 is connected to a first main electrode of the imaging switch element 2061, and a first electrode of the detection element 2052 is connected to a first main electrode of the detection switch element 2062. Second electrodes of the imaging element 2051 and the detection element 2052 are connected to the bias line 230. The first main electrodes of the imaging switch element 2061 and the detection switch element 2062 are connected to the same signal line 220. A control electrode of the imaging switch element 2061 is connected to the drive line 210, and a control electrode of the detection switch element 2062 is connected to the detection drive line 211.

A drive circuit 250 is configured to supply a drive signal to drive target pixels through the plurality of drive lines 210 and the detection drive line 211 in accordance with a control signal from a control unit 280. The drive lines 210 and the detection drive line 211 may be connected to different drive circuits. A configuration may be adopted in which, for example, the drive lines 210 are connected to a drive circuit for imaging, and the detection drive line 211 is connected to a drive circuit for detection of a radiation dose. A drive signal is a signal for switching on a switch element included in a drive target pixel. The switch element included in the pixel is switched on by a signal at a high level, and is switched off by a signal at a low level. For this reason, this signal at a high level is referred to as a “drive signal”. By the drive signal being supplied to a pixel, signals accumulated in the conversion element of this pixel is ready to be read out by a readout circuit 260.

The readout circuit 260 is configured to read out signals from the plurality of pixels through the plurality of signal lines 220. The readout circuit 260 includes a plurality of amplifiers 261, a multiplexer 262, and an analog-digital converter (hereinafter, A/D converter) 263. The plurality of signal lines 220 are connected to corresponding amplifiers 261 from among the plurality of amplifiers 261 of the readout circuit 260. One signal line 220 corresponds to one amplifier 261. The multiplexer 262 selects a plurality of amplifiers 261 in a predetermined order, and supplies a signal from a selected amplifiers 261 to the A/D converter (ADC) 263. The ADC 263 converts the supplied signal into a digital signal and outputs the digital signal.

Signals read out from the imaging pixels 201, the imaging-and-detection pixel 204, and the imaging pixels 207 in the AEC row are supplied to a signal processing unit 270, and are subjected to computation, storing, and the like by the signal processing unit 270. Specifically, the signal processing unit 270 includes a computation unit 271 and a storage unit 272. The computation unit 271 generates a radiological image based on signals read out from the imaging pixels 201, the imaging pixels 207, the imaging element 2051 of the imaging-and-detection pixel 204, and stores the radiological image in the storage unit 272. In addition, a signal read out from the detection element 2052 of the imaging-and-detection pixel 204 is supplied to the signal processing unit 270, and is subjected to computation, storing, and the like by the computation unit 271 of the signal processing unit 270. Specifically, the signal processing unit 270 generates irradiation information related to irradiation for the radiation imaging apparatus 102 based on the signal read out from the detection element 2052 of the imaging-and-detection pixel 204, and stores the irradiation information in the storage unit 272. The irradiation information includes information regarding a result of detecting irradiation for the radiation imaging apparatus 102 (information that can be used for detection of irradiation start), and information indicating the amount of irradiation and/or the accumulated irradiation amount (information that can be used for the AEC function), for example.

The control unit 280 controls the drive circuit 250 and the readout circuit 260 based on information from the signal processing unit 270. The control unit 280 controls, for example, start and end of exposure (electric charge accumulation in the imaging pixels 201 in response to irradiation) based on irradiation information stored in the storage unit 272 of the signal processing unit 270 (for example, irradiation amount) (AEC function). In order to obtain the irradiation information (irradiation amount), the control unit 280 controls the drive circuit 250 to scan only the detection drive line 211, and make only the signal of the detection element 2052 of the imaging-and-detection pixel 204 ready to be read out. Next, the control unit 280 controls the readout circuit 260 to read out a signal of a column corresponding to the detection element 2052, and obtains information indicating the irradiation amount. By performing such an operation, the radiation imaging apparatus 102 can obtain irradiation information in the imaging-and-detection pixel 204 during irradiation. In addition, the control unit 280 outputs (transmits) a radiological image stored in the storage unit 272 to the outside via a communication I/F 291.

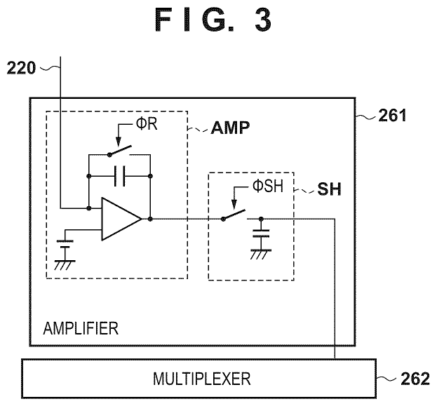

FIG. 3 shows a detailed exemplary circuit configuration of an amplifier 261. The amplifier 261 includes a differential amplifier circuit AMP and a sample hold circuit SH. The differential amplifier circuit AMP amplifies and outputs a signal that appeared on the signal line 220. The control unit 280 can reset the potential of the signal line 220 by supplying a control signal φR to a switch element of the differential amplifier circuit AMP. Output from the differential amplifier circuit AMP can be held by the sample hold circuit SH. The control unit 280 causes the sample hold circuit SH to hold a signal (output from the differential amplifier circuit AMP) by supplying a control signal φSH to a switch element of the sample hold circuit SH. The signal held in the sample hold circuit SH is read out by the multiplexer 262.

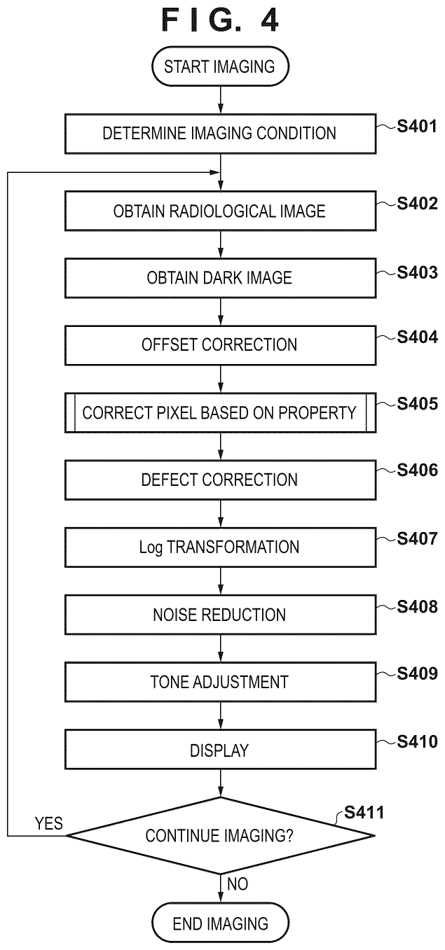

Next, processing from the start of imaging of the subject P until the end according to the first embodiment will be described with reference to the flowchart in FIG. 4. In step S401, the controller 103 accepts an imaging condition input by the user via an imaging condition input unit (user interface), and makes determination on the imaging condition. The imaging condition includes information such as a radiation dose target value, irradiation intensity (irradiation time (ms), a tube current (mA), a tube voltage (kV)), a light-receiving field where radiation is detected, in imaging segment, and the like. The controller 103 transmits the accepted imaging condition (including a radiation dose target threshold obtained based on the radiation dose target value), to the radiation generating apparatus 101 and the radiation imaging apparatus 102 via the radiation source interface 104 and the imaging interface 105 as appropriate. In addition, the imaging condition is also provided to the image processing unit 106.

In step S402, when an irradiation start operation performed by the by user is accepted through the exposure switch 110 after a preparation complete signal is received from the radiation imaging apparatus 102, the controller 103 causes the radiation generating apparatus 101 to start irradiation. Radiation imaging is thereby started, and a radiological image is obtained. More specifically, in accordance with the control apparatus 100 accepting the irradiation start operation after the preparation complete signal is received, an irradiation start signal instructing irradiation start is transmitted from the radiation source interface 104 to the radiation generating apparatus 101. Upon receiving the irradiation start signal, the radiation generating apparatus 101 emits radiation toward the subject P in accordance with the imaging condition (irradiation intensity) determined in step S401. The radiation imaging apparatus 102 determines that irradiation is to be started, based on the signal read out from the detection element 2052 of the imaging-and-detection pixel 204, and starts radiation imaging. In radiation imaging, radiation that has passed through the subject P and entered the radiation imaging apparatus 102 is converted into a radiation dose information signal for each imaging pixel. In the radiation imaging apparatus 102, the control unit 280 determines whether or not the accumulated value of doses of radiation emitted based on the signal from the detection element 2052 of the imaging-and-detection pixel 204 has reached the radiation dose target threshold. If it is determined that the accumulated value has reached the radiation dose target threshold, a notification unit 290 of the radiation imaging apparatus 102 transmits a stop notice requesting that irradiation be ended, through the communication I/F 291. When the stop notice is received by the imaging interface 105, the radiation source interface 104 instructs the radiation generating apparatus 101 to stop irradiation. In this manner, one instance of radiation imaging ends.

In step S403, the imaging interface 105 transmits a dark image obtaining signal to the radiation imaging apparatus 102. Upon receiving the dark image obtaining signal, the radiation imaging apparatus 102 obtains signals from the plurality of imaging pixel in a state where radiation is not emitted, and transmits the signals to the image processing unit 106. The image processing unit 106 generates a dark image based on the received signals from the pixels, and stores the dark image. In step S404, the image processing unit 106 performs offset correction on the obtained radiological image in step S402 (radiation dose information signal obtained from the imaging pixels). More specifically, the correction unit 162 of the image processing unit 106 subtracts the dark image obtained in step S403 from the radiological image obtained in step S402, and obtains a radiological image after offset correction.

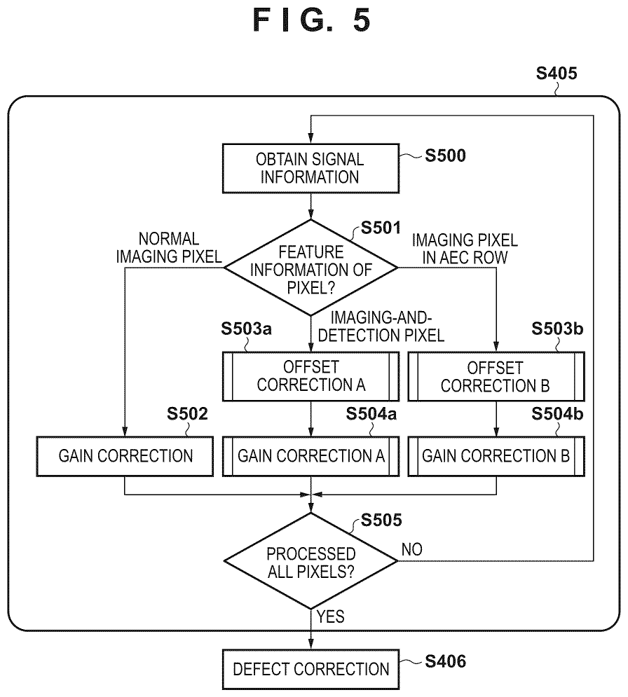

In step S405, the image processing unit 106 performs a correction process selected in accordance with feature information of pixels, on the pixels. In the present embodiment, feature information indicates types of imaging pixels, that is to say whether each imaging pixel is the normal imaging pixel, the imaging pixel in the AEC row, or the imaging-and-detection pixel. FIG. 5 shows a flowchart of the correction process in step S405.

In the present embodiment, the determination unit 161 determines a type of imaging pixel, for each of the pixel values of the radiological image subjected to offset correction, and the correction unit 162 applies a correction process determined in accordance with the determined type of imaging pixel, to the pixel value. In this manner, the correction unit 162 reduces or prevents a degradation in the image quality by switching a correction process in accordance with a type of imaging pixel (the property of the imaging pixel) determined by the determination unit 161.

Step S405 includes processing steps of steps S500 to S504, and these processing steps are repeated for all of the pixels (step S505). First, in step S500, signal information of a correction target pixel is obtained. The signal information includes feature information of the pixel, radiation dose information of the pixel, and the like. As described above, the feature information of the pixel specifies whether a radiation dose information signal that is a processing target has been obtained from the normal imaging pixel, the imaging-and-detection pixel, or the imaging pixel in the AEC row. In step S501, the determination unit 161 determines the property of the pixel (type of pixel) based on the feature information. A correction process to be performed on the pixel is determined based on this determination result. Note that a configuration may be adopted in which the signal information includes position information indicating the position (coordinates) of the pixel, and the type of pixel is obtained based on this position information and position information of the imaging-and-detection pixel held in advance. In this case, the determination unit 161 determines whether this pixel is the normal imaging pixel, the imaging pixel in the AEC row, or the imaging-and-detection pixel, based on the comparison between the position information included in the signal information and the position information of the imaging-and-detection pixel.

If the determination unit 161 determines that the radiation dose information signal has been obtained from the normal imaging pixel (an imaging pixel 201), the procedure advances to step S502. Note that the radiation dose information signal is a pixel value expressed in quantization unit (LSB) of A/D conversion performed by the ADC 263, and is hereinafter also simply referred to as a “pixel value”. In step S502, the correction unit 162 performs a gain correction process by dividing the pixel value of each pixel subjected to offset correction, by a corresponding pixel value of a gain image. Note that the gain correction process is a known process, and the gain image that is used for the gain correction process is obtained in advance by capturing a radiological image in which there is no subject, under a predetermined irradiation condition.

In step S501, if the determination unit 161 determines that the correction target pixel value is a pixel value that has been obtained from the imaging-and-detection pixel, the procedure advances to step S503a, and, if the determination unit 161 determines that the correction target pixel value is a pixel value obtained from the imaging pixel in the AEC row, the procedure advances to step S503b. The property of the imaging-and-detection pixel and the property of the imaging pixel in the AEC row are different, and thus are separately subjected to correction processes (the correction process of steps S503a and S504a and the correction process of steps S503b and S504b), respectively.

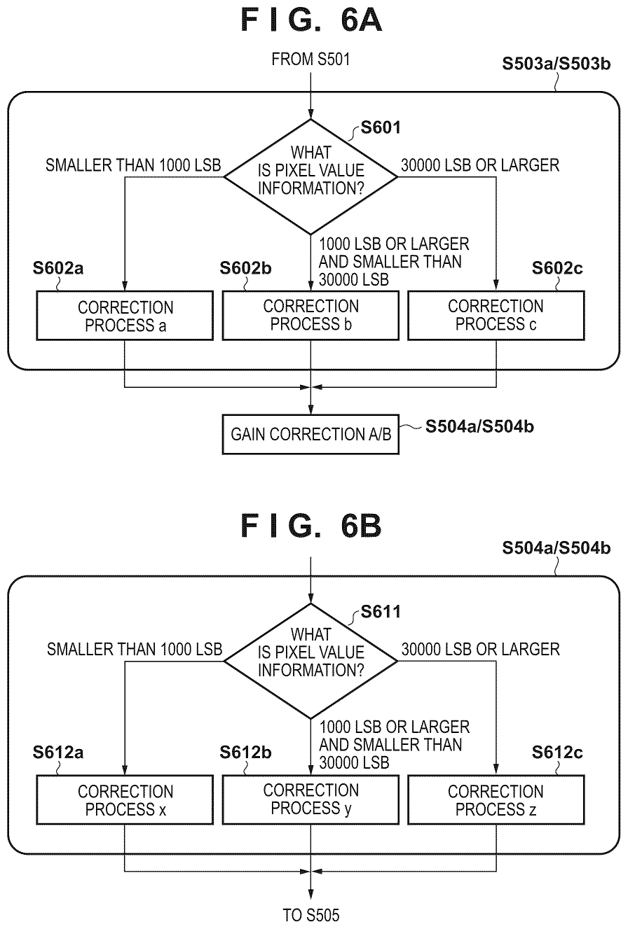

FIG. 6A is a flowchart showing processing of offset correction A/B in step S503a/S503b. An output decrease amount of the imaging-and-detection pixel or the imaging pixel in the AEC row changes in accordance with the dose of radiation that is output from the radiation generating apparatus 101. For this reason, the correction unit 162 determines a correction process to be applied, based on the radiation dose information signal included in the signal information obtained in step S500, and executes the determined correction process. If the feature information of the pixel indicates that the pixel is the imaging-and-detection pixel (step S503a), the correction unit 162 obtains pixel value information related to the correction-target imaging pixel based on the pixel values of a portion of the radiological image (radiation dose information signal) in step S601. The correction unit 162 determines which of the correction processes of steps S602a to S602c is to be performed, in accordance with the obtained pixel value information. Here, the pixel value information is the average value of radiation dose information signals (pixel values) obtained from normal imaging pixels surrounding the imaging-and-detection pixel, for example. It is possible to use, for example, the average value of pixel values obtained from total six normal imaging pixels, that is upper three imaging pixels and lower three imaging pixels among 3×3 pixels centered on the target imaging-and-detection pixel.

If, in step S601, the pixel value information is smaller than 1000 LSB, the procedure advances to step S602a, and the correction unit 162 performs correction using a correction value a obtained by substituting the pixel value information into an approximation formula a. Similarly, if the pixel value information is larger than or equal to 1000 LSB and smaller than 30000 LSB, the procedure advances to step S602b, and the correction unit 162 performs correction using a correction value b obtained by substituting the pixel value information into an approximation formula b. In addition, if the pixel value information is larger than or equal to 30000 LSB, the procedure advances to step S602c, and the correction unit 162 performs correction using a correction value c obtained by substituting the pixel value information into an approximation formula c. In steps S602a to S602c, the correction processes a to c for subtracting (or adding) the correction values a to c from (to) the radiation dose information signal (pixel value) to be corrected are performed, respectively. Hereinafter, the correction processes of steps S602a to S602c will be referred to as “offset correction”. The purpose of the correction processes of step S503a (steps S602a to S602c) is to correct the pixel value from the imaging-and-detection pixel that could not be corrected in offset correction executed in step S404, and to correct the offset property different from that of the normal imaging pixel. The approximation formulas a to c are generated in advance based on a result of measuring a change in the offset property (correction residual amount) that is based on the irradiation dose in the imaging-and-detection pixel 204, based on a radiological image and a dark image obtained by the radiation imaging apparatus 102. After step S503a, the procedure advances to step S504a.

Processing in a case where feature information of a pixel indicates that the pixel is the imaging pixel in the AEC row (step S503b) is also processing similar to step S503a described above. Note that a correction value that is used in step S503b is determined independently from step S503a. The approximation formulas a to c are generated in advance based on a result of measuring a change in the offset property (correction residual amount) that is based on the irradiation dose in the imaging pixel 207 in the AEC row, based on a radiological image and a dark image obtained by the radiation imaging apparatus 102. The purpose of step S503b is to correct the pixel value from the imaging pixel in the AEC row that could not be corrected in offset correction executed in step S404. After step S503b, the procedure advances to step S504b.

FIG. 6B is a flowchart showing processing of gain correction A/B of step S504a/S504b. In the case of the imaging-and-detection pixel (step S504a), for example, in step S611, the correction unit 162 determines which of the correction processes of steps S612a to S612c is to be performed, based on the pixel value information. The average value (note that pixel values subjected to offset correction will be used) obtained using a method similar to step S601 can be used as the pixel value information, for example. Note that, in step S611, pixel value information obtained from a radiological image for which offset correction has been completed by performing step S503a is used. In steps S612a to S612c, correction processes x to z for compensating for an output decrease amount by dividing (or multiplying) the radiation dose information signal (pixel value) to be corrected, by the correction values x to z (gain correction values) set for the respective correction processes are performed.

If the pixel value information is smaller than 1000 LSB (where LSB is a quantization unit), the procedure advances to step S612a, and the correction unit 162 performs correction using the correction value x obtained by substituting the pixel value information into the approximation formula x. If the pixel value information is larger than or equal to 1000 LSB and smaller than 30000 LSB, the procedure advances to step S612b, and the correction unit 162 performs correction using the correction value y obtained by substituting the pixel value information into the approximation formula y. If the pixel value information is larger than or equal to 30000 LSB, the procedure advances to step S612c, and the correction unit 162 performs correction using the correction value z obtained by substituting the pixel value information into the approximation formula z. In steps S612a to S612c, correction processes for dividing (or multiplying) correction values are performed, respectively, and, hereinafter, the correction processes of step S612a to S612c will also be referred to as “gain correction”. The approximation formulas x to z are generated based on a result of measuring correction values that are based on the irradiation dose of the imaging-and-detection pixel 204, based on a plurality of gain images obtained by the radiation imaging apparatus 102 for a plurality of irradiation doses, and are held in the correction unit 162. The purpose of the correction process of step S504a is to perform gain correction on a pixel value from the imaging-and-detection pixel after offset correction, using a correction value selected in accordance with the property and pixel value information of the pixel. By performing this correction process, an appropriate gain correction value is used for a pixel value from an imaging pixel (imaging-and-detection pixel) having a different property, in accordance with an irradiation dose. As a result, depending on an irradiation dose, an output abnormality that has occurred in an imaging pixel having a different property is solved or reduced. The process of step S504b that is executed in a case where feature information indicates the imaging pixel in the AEC row is similar to the process of step S504a. Note that the approximation formulas x to z are generated for the imaging pixel in the AEC row, and correction values are determined independently from the imaging-and-detection pixel.

Note that, in addition to the radiation dose information signal, an imaging condition input using the controller 103 may be taken into consideration. A configuration may be adopted in which, in steps S602a to S602c and/or steps S612a to S612c, for example, an approximation formula is switched further based on the imaging condition. Note that the imaging condition includes at least one of an irradiation time, a tube current, and a tube voltage, for example. A configuration may also be adopted in which, for example, an approximation formula for determining a correspondence between pixel value information and a correction value for each tube voltage is prepared, and an approximation formula that is used is switched in accordance with an imaging condition.

Returning to FIG. 4, in step S406, the correction unit 162 performs a defect correction process on a defective pixel indicated by pixel information held by the radiation imaging apparatus 102, in the radiological image for which pixel correction was performed based on the properties in step S405. In step S406, a known defect correction process can be used. In step S407, the image processing unit 106 performs Log transformation processing on a radiation dose information signal for each pixel for which the defect correction was performed in step S406. In step S408, the image processing unit 106 performs processing for reducing noise included in the radiation dose information signal (noise reducing processing), on the radiation dose information signal of each pixel for which Log transformation processing was performed in step S407. The noise reducing processing is known processing, and is performed based on the tube voltage, the tube current, and information regarding the imaging segment received in step S401 by the image processing unit 106, for example. In step S409, the image processing unit 106 performs processing for adjusting tone (tone processing) on the radiation dose information signal of each pixel after noise reducing processing was performed in step S409. Tone processing is performed based on the imaging condition received by the image processing unit 106 in step S401.

In step S410, the image processing unit 106 transmits signals subjected to tone adjustment in step S409, to the display unit 107. The display unit 107 displays the signals received from the image processing unit 106 as a two-dimensional image. In step S411, the controller 103 determines whether to continue or end imaging based on an instruction input from the operator. If the controller 103 determines that imaging is to be continued (YES in step S411), the procedure returns to step S402, and a radiological image is captured again by repeating the above processing. On the other hand, if the controller 103 determines that imaging is to be ended (NO in step S411), processing for imaging a subject ends.

Note that there is a so-called fixed dark that is a method in which a dark image obtained in step S403 during first radiation imaging while imaging is continued is used for offset correction in second and subsequent radiation imaging. In fixed dark, a dark image obtained in first radiation imaging is used for offset correction in second and subsequent radiation imaging. For this reason, in a case where fixed dark is used, step S403 is skipped in second and subsequent radiation imaging.

In addition, in steps S503a/S503b and S504a/S504b, a range of classification of pixel value information for determining an approximation formula to be used, from three approximation formulas is not limited to the range illustrated in FIGS. 6A and 6B. In addition, a range of classification of pixel value information may differ between a case where the imaging-and-detection pixel is processed and a case where the imaging pixel in the AEC row is processed. In addition, in steps S503a/S503b and S504a/S504b, three approximation formulas are prepared, from which an approximation formula to be used is determined, but there is no limitation thereto, and an approximation formula to be used may be determined from two approximation formulas, or may be determined from four or more approximation formulas. In addition, a correction value may be determined by substituting pixel value information into one approximation formula. In this case, branching that is based on the pixel value information in steps S601 and S611 can be omitted. Furthermore, the number of approximation formulas that are prepared may differ between the imaging-and-detection pixel and an imaging pixel in the AEC row.

As described above, an approximation formula is determined in advance such that a correction value for bringing a pixel value obtained from a correction-target imaging pixel closer to a pixel value obtained from a normal imaging pixel is obtained, by substituting pixel value information into the approximation formula. In addition, a correction value may be determined by referencing a numerical value table in place of an approximation formula. In this case, the relation between the pixel value information and the correction value for bringing the pixel value obtained from the correction-target imaging pixel, closer to the pixel value obtained from the normal imaging pixel is held in the numerical value table. In addition, in a case where the numerical value table is used, branching that is based on the pixel value information in steps S601 and S611 can be omitted. In addition, a configuration may be adopted in which numerical value tables are prepared for respective imaging conditions, a numerical value table selected in accordance with an imaging condition is referenced, and a correction value corresponding to pixel value information is obtained.

Similarly to an approximation formula, the numerical value table that is used in steps S602a to S602c is also generated based on actual measurement values obtained using the radiation imaging apparatus 102. The relation in amount of imaging-and-detection pixels and the imaging pixels in the AEC row that cannot be corrected (correction residual amount) is measured based on a radiological image and a dark image obtained from the radiation imaging apparatus 102, for example. A numerical value table is then determined such that the correction residual amount is eliminated based on the relation between the pixel value information and the measured correction residual amount, for example. In addition, a numerical value table that is used in steps S612a to S612c can also be obtained based on actual measurement values obtained using the radiation imaging apparatus 102, similarly to an approximation formula. A numerical value table can be generated by determining a correction value for each value in the radiation dose value information the difference in output that depends on a type of imaging pixel is absorbed based on a plurality of gain images obtained under different irradiation conditions, for example. Note that, in a case where the numerical value table is used, a correction value corresponding to pixel value information that is not present in the numerical value table may be interpolated and obtained. In addition, a switch may be made between the use of an approximation formula and a numerical value table in accordance with pixel value information, and, for example, an approximation formula is used as in step S602a and a numerical value table is used in step S602b.

Note that a configuration may be adopted in which, when obtaining a dark image and a gain image, a signal from only the imaging element of the imaging-and-detection pixel is used, or the sum of signals from the imaging element and the detection element is used. The approximation formula and the numerical value table vary in accordance with how a signal from the imaging-and-detection pixel is handled when a dark image and a gain image are obtained.

The pixel values from six (upper and lower) normal imaging pixels among the pixels surrounding the imaging-and-detection pixel or the imaging pixel in the AEC row are used as pixel value information that is used to determine a correction value, but there is no limitation thereto. The average of pixel values from three normal imaging pixels arranged over the imaging-and-detection pixel or the imaging pixel in the AEC row may be used, for example. In addition, a pixel value obtained from the imaging-and-detection pixel or the imaging pixel of the AEC row that is a correction-target imaging pixel may be used, or the ratio between the average value and the pixel value obtained from the correction-target imaging pixel may also be used.

As another aspect, in determination of a correction value in steps S503a/S503b and S504a/S504b, a time that has elapsed from when the radiation imaging apparatus 102 was turned on or from when imaging ended until when a preparation complete signal is output may also be taken into consideration. As described above, after the radiation imaging apparatus 102 is turned on, or each time one instance of radiation imaging is ended, the radiation imaging apparatus 102 performs an operation of resetting an electric circuit, and outputs a preparation complete signal when preparation for imaging is complete. The radiation imaging apparatus 102 notifies the control apparatus 100 of the elapsed time from when the reset operation was started until when the preparation complete signal is output, and the control apparatus 100 can thereby obtain the elapsed time. Alternatively, the control apparatus 100 may measure an elapsed time from when a signal corresponding the radiation imaging apparatus 102 being turned on or end of imaging was received from the radiation imaging apparatus 102 until when the imaging preparation complete signal is received. In addition, as another aspect, a configuration may be adopted in which both offset correction in steps S602a to S602c and gain correction in steps S612a to S612c are executed, and step S504a/S504b is omitted. In this case, correction values for offset correction and gain correction are determined based on determination on pixel value information in step S601. Furthermore, as another aspect, a configuration may be adopted in which step S502a/S503b is omitted, and only gain correction is executed. In this case, in order to determine a correction value, an approximation formula or a numerical value table in which both offset correction and gain correction are taken into consideration may be used.

As described above, according to the first embodiment, by switching a correction process in accordance with property of a pixel (the normal imaging pixel, the imaging pixel in the AEC row, and the imaging-and-detection pixel), it is possible to reduce or prevent a degradation in the image quality caused by the difference in property between pixels.

### Second Embodiment

In the first embodiment, a case has been described in which the properties of the normal imaging pixel, the imaging pixel in the AEC row, and the imaging-and-detection pixel are different. In a second embodiment, a case will be described in which the properties of the normal imaging pixel and the imaging pixel in the AEC row are similar, and the property of the imaging-and-detection pixel 204 is different. The following configuration is conceivable as a configuration in which the properties of the normal imaging pixel (the imaging pixels 201) and the imaging pixel in the AEC row (the imaging pixels 207) are similar. A configuration may be adopted in which, for example, the aperture rate of the normal imaging pixel that does not include the detection drive line 211 is restricted such that the aperture rate of the normal imaging pixel and the aperture rate of the imaging pixel in the AEC row are similar. Alternatively, a configuration may be adopted in which the detection drive line 211 is disposed on a lower layer than the imaging elements, and the aperture rate of the imaging pixel in the AEC row and the aperture rate of the normal imaging pixel are maintained to be similar.

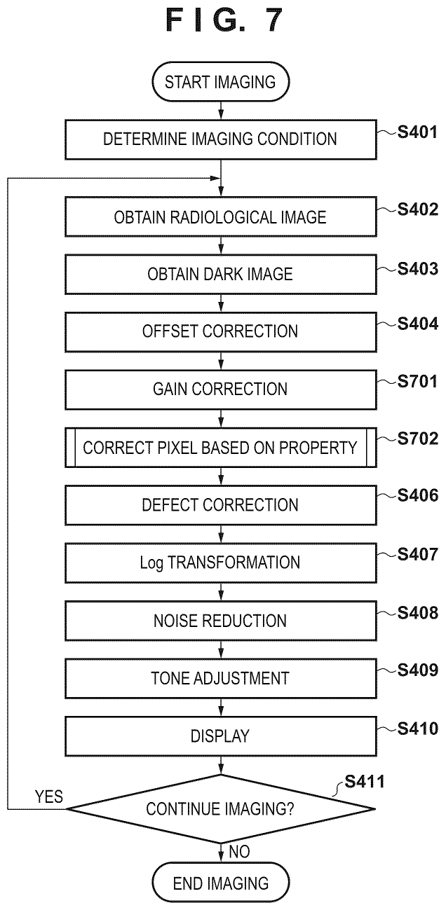

The configuration of the radiation imaging system 10 according to the second embodiment is similar to that of the first embodiment (FIGS. 1, 2, and 3). FIG. 7 is a flowchart describing radiation imaging processing according to the second embodiment. Difference from the flowchart in the first embodiment (FIG. 4) is that the processing of step S405 is replaced with steps S701 and S702. That is to say, in the second embodiment, after offset correction (step S404) and gain correction (step S701) are performed on the radiological image obtained in step S402, a correction process that uses a correction value that is based on the property is performed (step S702).

First, in step S701, the image processing unit 106 performs a gain correction process on a radiological image after offset correction. Then, in step S702, the determination unit 161 and the correction unit 162 perform pixel correction that is based on the property. Pixel correction in step S702 is executed by designating all of the pixels of the radiological image as processing targets.

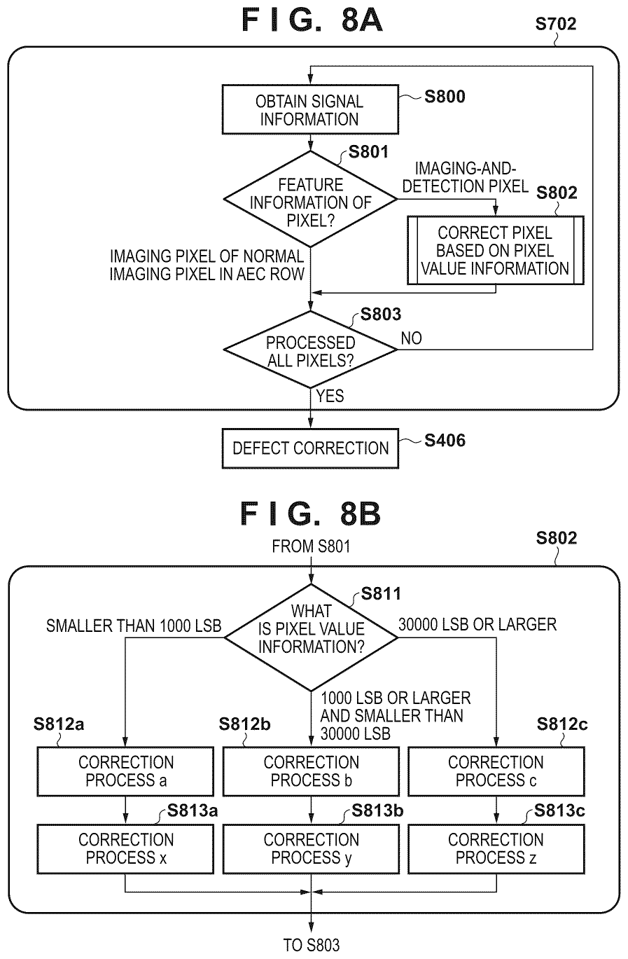

FIG. 8A is a flowchart showing a correction process in step S702. Step S702 includes processing steps of steps S800 to S802, and these processing steps are repeated for all of the pixels (step S803). First, in step S800, signal information of a correction-target pixel is obtained. In step S801, the determination unit 161 determines whether the processing-target pixel is the normal imaging pixel, the imaging pixel in the AEC row, or the imaging-and-detection pixel using feature information of the pixel included in the obtained signal information. In the present embodiment, as described above, the normal imaging pixel and the imaging pixel in the AEC row have similar properties, and are handled as the same type of imaging pixels. That is to say, an output decrease such as that of the imaging-and-detection pixel 204 does not occur in the normal imaging pixel or the imaging pixel in the AEC row. Therefore, if the determination unit 161 determines that the correction-target imaging pixel is the normal imaging pixel or the imaging pixel in the AEC row, step S802 is skipped, and correction that is based on the feature information and the pixel value is not performed. On the other hand, if the determination unit 161 determines that the processing-target pixel is the imaging-and-detection pixel, the procedure advances to step S802. In step S802, the correction unit 162 performs a correction process determined based on pixel values of a portion of a radiological image, on the processing-target pixel.

FIG. 8B is a flowchart showing a correction process in step S802. An output decrease amount caused by the property of the imaging-and-detection pixel 204 changes in accordance with an irradiation dose. For this reason, in step S811, the determination unit 161 determines a correction process to be applied to the processing-target pixel, in accordance with the pixel value information of the correction-target imaging pixel. The pixel value information has been described in the first embodiment (steps S601 and S611). In this example, the pixel value information is classified into three ranges, that is, 1000 LSB or smaller, 1000 LSB or larger and smaller than 30000 LSB, and 30000 LSB or larger. In steps S812a to S812c, the correction unit 162 performs correction processes a to c for subtracting (or adding) correction values a to c determined based on the pixel value information and approximation formulas a to c from (to) the correction target pixel value. The processing of steps S812a to S812c is similar to the processing of steps S602a to S602c in the first embodiment. Then, in steps S813a to S813c, the correction unit 162 performs correction processes x to z for dividing (or multiplying) the correction target pixel value by the correction values x to z determined based on the pixel value information and approximation formulas x to z. The processing of steps S813a to S813c is similar to the processing of steps S612a to S612c in the first embodiment.

After the processing of steps S800 to S802 is performed on the pixel values of all of the imaging pixels of the radiological image, the procedure advances to step S406 in FIG. 7. In step S406, the correction unit 162 performs known defect correction on the radiological image. Note that, in the processing of step S802 shown in FIG. 8B, steps S812a to S812c may be omitted. In that case, in steps S813a to S813c, a correction process for dividing (or multiplying) the correction-target pixel value by a correction value determined in consideration of offset correction may be performed. In addition, a configuration has been described above in which a correction process is applied by assuming that the properties of the normal imaging pixel and the imaging pixel in the AEC row being similar, but, similarly to the first embodiment, the normal imaging pixel and the imaging pixel in the AEC row may be handled as imaging pixels having different properties (different types of imaging pixels). In that case, also if it is determined in step S801 that the processing-target pixel signal is performed than imaging pixel in the AEC row, pixel correction that is based on pixel value information (note that a correction process that is independent from pixel correction of the imaging-and-detection pixel is used) is executed. In addition, in classification of properties of imaging pixels (step S501) according to the first embodiment, the normal imaging pixel and the imaging pixel in the AEC row may be regarded as imaging pixels having the same property (the same type) as with the second embodiment.

As described above, according to the second embodiment, by applying correction that is based on the properties to the pixel values after offset correction and gain correction, it is possible to reduce or prevent a degradation in the image quality caused by the difference in property between pixels.

### Third Embodiment

There are cases where, on a line on which the imaging-and-detection pixel 204 is disposed or a line on which the imaging-and-detection pixel 204 and the imaging pixels 207 are arranged, correction errors are noticeable in high-contrast regions, such as regions of a metal device and an implant. The present inventor has found that, in such a case, by performing defect correction in a specific situation such as when output from the imaging-and-detection pixel 204 and the imaging pixels 207 is in a state of low output, saturation, or high output near saturation, the occurrence of an artifact can be prevented even in a high-contrast image. In the third embodiment, a configuration for further improving the image quality by setting the imaging-and-detection pixel 204 as a defective pixel, in other words, a defect correction target in accordance with a radiation dose information signal, in a specific case such as a case of low output or high output, will be described.

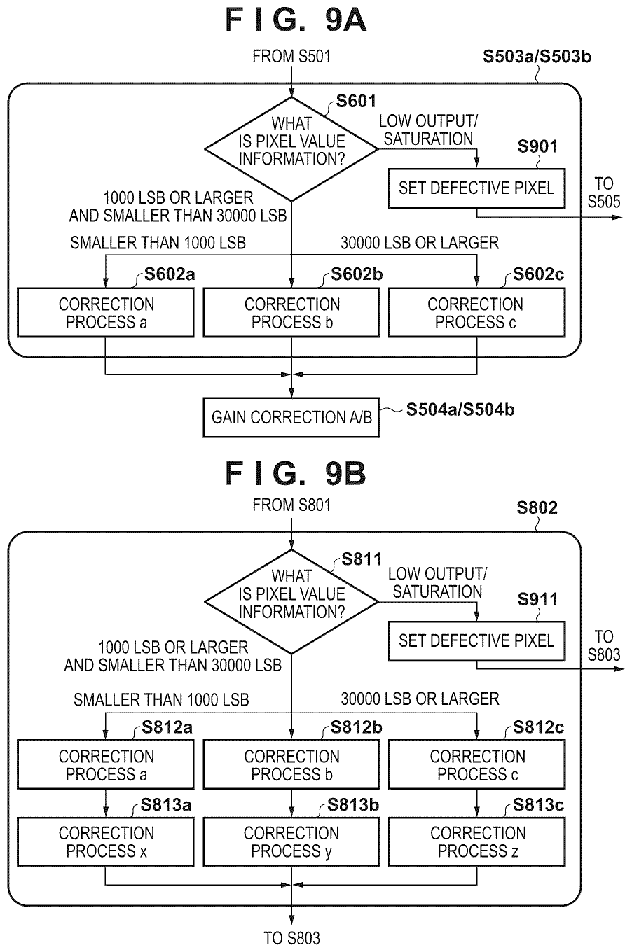

The configuration of the radiation imaging system 10 according to the third embodiment is similar to that of the first embodiment (FIGS. 1, 2, and 3). In addition, although radiation imaging processing is similar to that of the first embodiment (FIGS. 4, 5, 6A, and 6B), the processing of step S503a/S503b is different. FIG. 9A is a flowchart showing the processing of step S503a/S503b according to the third embodiment. In step S601, the determination unit 161 performs determination as low output if the pixel value information is smaller than a first threshold (for example, 500 LSB). In addition, the determination unit 161 performs determination as saturation or high output near saturation (hereinafter, simply referred to as “saturation”) if the pixel value information is larger than a second threshold (for example, 50000 LSB). If the pixel value of a correction-target imaging pixel is determined as low output or saturation, based on the pixel value information, the procedure advances to step S901. In step S901, the correction unit 162 sets pixel information of the imaging pixel as a defective pixel, and skips the correction processes a to c (steps S602a to 602c) and gain correction (step S504a/504b). In step S406 in FIG. 4, defect correction is performed on the pixel value of the imaging pixel set as a defective pixel, in the pixel information. In this manner, by defect correction being performed in which the imaging-and-detection pixel and imaging pixel in the AEC row in a state of low output or saturation are regarded as defective pixels, the image quality of a radiological image improves.

Although processing according to the third embodiment that is based on radiation imaging processing according to the first embodiment has been described above, a configuration can also be adopted in which a low output or saturation state is detected in radiation imaging processing according to the second embodiment. FIG. 9B is a flowchart showing the processing of step S802 according to the second embodiment (FIG. 8B). In step S811, the determination unit 161 makes determination as low output if the pixel value information is smaller than a first threshold, and makes determination as saturation if the pixel value information is larger than a second threshold. If the determination unit 161 makes determination as low output or saturation based on the pixel value information, the procedure advances to step S911. In step S911, the correction unit 162 sets the pixel information of the imaging pixel as a defective pixel, and skips the subsequent correction processes a to c (steps S812a to 812c) and the correction processes x to z (steps S813a to 813c). In step S406 in FIG. 7, defect correction is performed on the pixel designated as a defective pixel based on the pixel information. In this manner, the imaging pixel or the imaging-and-detection pixel in a state of low output or saturation is regarded as a defective pixel and defect correction is performed, thus improving the image quality of the radiological image.

According to the present disclosure, the image quality of a radiological image that is obtained from a radiation imaging apparatus in which imaging pixels having different properties are present due to structural difference improves.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to

exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-018021, filed Feb. 8, 2024 which is hereby incorporated by reference herein in its entirety.

What is claimed is:

1. An image processing apparatus comprising:
one or more controllers configured to: obtain a radiological image that includes a plurality of pixel values obtained from a plurality of imaging pixels through radiation imaging, wherein the plurality of imaging pixels are two-dimensionally arranged;
determine, from among the plurality of pixel values, a pixel value obtained from a first type of imaging pixel of the plurality of imaging pixels and a pixel value obtained from a second type of imaging pixel having a different configuration from the first type of imaging pixel; and
perform a first correction process in which the pixel value obtained from the first type of imaging pixel is set as a correction target, and perform a second correction process that is different from the first correction process, and in which the pixel value obtained from the second type of imaging pixel is set as a correction target,
wherein, in the second correction process, a correction process to be applied to the correction-target pixel value is determined based on pixel value information obtained from a pixel value of a portion of the radiological image.

2. The image processing apparatus according to claim 1, wherein the first type of imaging pixel has a configuration in which a single conversion element is disposed in a region of one pixel, the second type of imaging pixel has a configuration in which two conversion elements each capable of reading out an electric charge independently are disposed in a region of one pixel, and a pixel value is provided from a first conversion element that is one of the two conversion elements.

3. The image processing apparatus according to claim 2, wherein the one or more controllers: further determine, among the plurality of pixel values, a pixel value obtained from a third imaging element included in a third type of imaging pixel having a configuration different from those of the first type of imaging pixel and the second type of imaging pixel,
the one or more controllers perform the second correction process on a pixel value obtained from the third type of imaging element, and
the second correction process determines a correction process that is applied to the pixel value from the third type of imaging pixel based on the pixel value information, independently from the correction process that is applied to the pixel value from the second type of imaging pixel.

4. The image processing apparatus according to claim 3, wherein the third type of imaging pixel has a configuration in which a single conversion element connected to the same drive line as the first conversion element of the second type of imaging pixel is disposed in a region of one pixel, and a drive line of a second conversion element that is the other of the two conversion elements passes through the region.

5. The image processing apparatus according to claim 1, wherein the first correction process includes offset correction that uses a dark image and gain correction that uses a gain image, and
in the second correction process, a correction process that is determined based on the pixel value information is performed on a pixel value subjected to the offset correction.

6. The image processing apparatus according to claim 1, wherein the first correction process includes offset correction that uses a dark image and gain correction that uses a gain image, and
in the second correction process, a correction process determined based on the pixel value information is performed on a pixel value subjected to the offset correction and the gain correction.

7. The image processing apparatus according to claim 5, wherein the second correction process includes a correction process for adding or subtracting a first correction value determined based on the pixel value information to or from the pixel value.

8. The image processing apparatus according to claim 5, wherein the second correction process includes a correction process for multiplying or dividing a second correction value determined based on the pixel value information by the pixel value.

9. The image processing apparatus according to claim 1, wherein, in the second correction process, a correction process is further determined based on an imaging condition.

10. The image processing apparatus according to claim 9, wherein the imaging condition includes an irradiation time, a tube voltage, and a tube current that are set in a radiation generating apparatus that is used for the radiation imaging.

11. The image processing apparatus according to claim 1, wherein, in the second correction process, a correction process is further determined based on an elapsed time from when a radiation imaging apparatus is turned on or one instance of radiation imaging ends until when preparation for the next radiation imaging is complete.

12. The image processing apparatus according to claim 1, wherein, in the second correction process, a correction value obtained by substituting a value determined based on the pixel value information into an approximation formula is used, and
the approximation formula is determined in advance so as to perform conversion into a correction value for bringing a pixel value obtained from a correction-target imaging pixel closer to a pixel value obtained from the first type of imaging pixel.

13. The image processing apparatus according to claim 1, wherein, in the second correction process, a value determined based on the pixel value information and a correction value obtained by referencing a numerical value table are used, and
the numerical value table holds a relation between a correction value for bringing a pixel value obtained from a correction-target imaging pixel closer to the pixel value obtained from the first type of imaging pixel and a value determined based on the pixel value information.

14. The image processing apparatus according to claim 1, wherein, in the second correction process, a correction-target imaging pixel is set as a defective pixel that is a defect correction target, based on the pixel value information.

15. The image processing apparatus according to claim 1, wherein, in the second correction process, a correction process is determined based on one of an average value of pixel values obtained from a plurality of first-type imaging pixels that surround a correction-target imaging pixel, a pixel value obtained from the correction-target imaging pixel, and a ratio of the average value to the pixel value obtained from the correction-target imaging pixel.

16. The image processing apparatus according to claim 1, wherein the one or more controllers determine whether an imaging pixel that provides a pixel value is the first type of imaging pixel or the second type of imaging pixel, based on positions of the plurality of pixel values in a radiological image that are included in the pixel value information.

17. A radiation imaging system that includes a radiation imaging apparatus and an image processing apparatus,
wherein, in the radiation imaging apparatus, a plurality of imaging pixels are two-dimensionally arranged, the plurality of imaging pixels including a first type of imaging pixel that has a configuration in which a single conversion element is disposed in a region of one pixel, and a second type of imaging pixel having a configuration in which two conversion elements each capable of reading out an electric charge independently are disposed in a region of one pixel, and a pixel value is provided from one of the two conversion elements,
the image processing apparatus that processes a radiological image that includes a plurality of pixel values obtained from the plurality of imaging pixels through radiation imaging that is performed using the radiation imaging apparatus, the image processing apparatus including:
one or more controllers configured to: determine, among the plurality of pixel values, a pixel value obtained from the first type of imaging pixel and a pixel value obtained from the second type of imaging pixel, and
perform a first correction process in which the pixel value obtained from the first type of imaging pixel is set as a correction target, and perform a second correction process that is different from the first correction process, and in which the pixel value obtained from the second type of imaging pixel is set as a correction target,
wherein, in the second correction process, a correction process to be applied to the correction-target pixel value is determined based on pixel value information obtained from a pixel value of a portion of the radiological image.

18. The radiation imaging system according to claim 17, wherein a first conversion element out of the two conversion elements provides a pixel value, and the radiation imaging apparatus performs automatic exposure control based on radiation dose information detected from a second conversion element out of the two conversion elements that is different from the first conversion element.

19. An image processing method comprising:
obtaining a radiological image that includes a plurality of pixel values obtained from a plurality of imaging pixels through radiation imaging, wherein the plurality of imaging pixels are two-dimensionally arranged;
determining, from among the plurality of pixel values, a pixel value obtained from a first type of imaging pixel of the plurality of imaging pixels and a pixel value obtained from a second type of imaging pixel having a different configuration from the first type of imaging pixel; and
performing a first correction process in which the pixel value obtained from the first type of imaging pixel is set as a correction target, and performing a second correction process that is different from the first correction process, and in which the pixel value obtained from the second type of imaging pixel is set as a correction target,
wherein, in the second correction process, a correction process to be applied to the correction-target pixel value is determined based on pixel value information obtained from a pixel value of a portion of the radiological image.

20. A non-transitory computer-readable storage medium storing a program for causing a computer to execute the method according to claim 19.
